(19) United States
(12) Patent Application Publication
(10) Pub. No.: US 2006/0146554 A1
(43) Pub. Date: Jul. 6, 2006

(54) Funeral Procession Vehicular Identification Apparatus and Method

(76) Inventor: Michael J. Bauer, East Berne, NY (US)

Correspondence Address: LAW OFFICE OF JAY R. YABLON, 910 NORTHUMBERLAND DRIVE, SCHENECTADY, NY, 12309-2814, US

(21) Appl. No.: 11/279,271

(22) Filed: Apr. 11, 2006

(51) Int. Cl. B60Q 1/26

(52) U.S. Cl. 362/493

(57) ABSTRACT

Disclosed is an apparatus for identifying a motor vehicle in a funeral procession, comprising: a purple-colored dome; and a light-emitting apparatus contained within the purple-colored dome and emitting purple-colored light through the purple-colored dome. Also disclosed is a related method of identifying a motor vehicle in a funeral procession, comprising: mounting an apparatus emitting purple-colored light atop the vehicle; and activating the apparatus to emit the purple-colored light from atop the vehicle.

### FIELD OF THE INVENTION

This invention related to an apparatus and method to clearly identify vehicles which are part of a funeral procession, so that people in the procession can maintain visual contact with one another to avoid separation while driving, and people not part of the procession can be alerted to the procession to maintain safety as well as respect.

### BACKGROUND OF THE INVENTION

In the modern automotive era, everyone from time to time has the unfortunate experience of traveling from a funeral home to a cemetery as part of a funeral procession. Even when one is not part of such a procession, an ordinary driver also from time to time will come upon the procession and, once aware of the procession, will want to drive in a manner which is respectful to the funeral participants, and which avoids collision with the vehicles in the procession.

The key issue, of course, is one of enabling vehicles which are part of the procession to be easily, visually distinguished from those which are not. Traditionally, this is achieved merely by having the cars in the procession turn on their headlights. This, however, is of limited effectiveness. Vehicles not part of the procession coming up from behind, for example, will not realize that there is a procession until they have moved in front of one or more procession vehicles, and by observation of a train of slower-moving procession vehicles as well as observation through the rear-view mirror of the illuminated headlights, deduced that they have come upon a funeral procession. Also, because many vehicles have daytime lights which are set to be always on, the fact that a headlight is on during daytime is no longer a mark of anything unusual. It is therefore desirable to signal that a car is part of a funeral procession, in a manner that can be observed from all directions and not just from a vehicles headlights or from the fact that a line of vehicles appears to be moving slowly and staying together.

A number of U.S. Patents have sought to allow certain vehicles or vehicular situations to be identified to others via various signs and/or flags. U.S. Pat. No. 2,483,058, for example, is a lighted sign indicating that a vehicle is parked adjacent to a roadway. U.S. Pat. No. 3,284,938 is for a display advertising device. U.S. Pat. No. 5,471,773 is for an illuminated vehicular sign. U.S. Pat. No. 6,056,425 is an illuminated taxi sign, which also enables a taxi driver to signal for help in the event, for example, of a crime or medical emergency. U.S. Pat. No. 6,063,459 is for an antenna ornament.

U.S. Pat. Nos. 2,546,855; 2,764,122; 3,075,492; 3,280,790; and 5,590,621 are for various flags and/or flagstaffs for a vehicular flag which indicate, specifically, that a vehicle is part of a funeral procession. Such signs may be difficult to see from all views, and are not as easy to identify as, for example, an illuminated signal.

U.S. Pat. No. 3,305,961 is for a sign which includes illumination. U.S. Pat. No. 5,913,616 is a light mounted to the rearview mirror. This is of limited utility because it is situated inside the vehicle and can only be seen through the front windshield. U.S. Pat. No. 6,599,001, which is the patent issued on published application 2002/0177356, is a funeral flag with a light at the top.

Insofar as lights specifically designed for roof mount for funerals, U.S. Pat. No. 6,082,880 appears to be for an illuminated, roof-mounted light in the shape of a religious symbol such as a cross or a star. U.S. Design Pat. D410,208; and D410,401 are mounted above the driver's window, and, respectively, are for illuminated flower and a cross designs.

Police vehicles typically employ blue lights, and indeed, blue has been identified universally as the warning light color for police cars. Similarly, red has been identified as the universal color for fire vehicle lighting. No such easily-recognizable standard exists with respect to funeral processions.

While the issue of distinguishing vehicles in a funeral procession from other cars therefore has received some attention as a problem to be addressed, and while solutions ranging from turning on the headlights to mounting an illuminated religious symbol (or a flower) on the roof have been considered, none of these solutions combines all of the characteristics which would be desirable in an optimal solution. This includes not only clear visibility from all views and under all lighting conditions, but also a simplicity and ease of immediate recognition. In an optimal solution, it should be as easy and clear to identify a car in a funeral procession, as it is, for example, to identify a police vehicle or a fire or medical emergency vehicle. Craning ones neck to read printed matter, or having any ambiguity as to what a particular signaling device may mean, defeats the purpose of clear and simple identification from all views and under all conditions, of a vehicle in a funeral procession. Additionally one should not even need to look directly at the vehicle to recognize that it is in a funeral procession. The emission of a suitable and recognizable type of light which can be observed even if one is not looking directly at the vehicle, provides a particularly optimal approach.

### SUMMARY OF THE INVENTION

Disclosed is an apparatus for identifying a motor vehicle in a funeral procession, comprising: a purple-colored dome; and a light-emitting apparatus contained within the purple-colored dome and emitting purple-colored light through the purple-colored dome. Also disclosed is a related method of identifying a motor vehicle in a funeral procession, comprising: mounting an apparatus emitting purple-colored light atop the vehicle; and activating the apparatus to emit the purple-colored light from atop the vehicle.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) and appendices summarized below.

FIG. 1 is a perspective view of a purple funeral procession identification light in accordance with an embodiment of the invention.

FIG. 2 is a perspective view illustrating the mounting of the purple funeral procession identification light of FIG. 1 atop a vehicle in a funeral procession.

### DETAILED DESCRIPTION

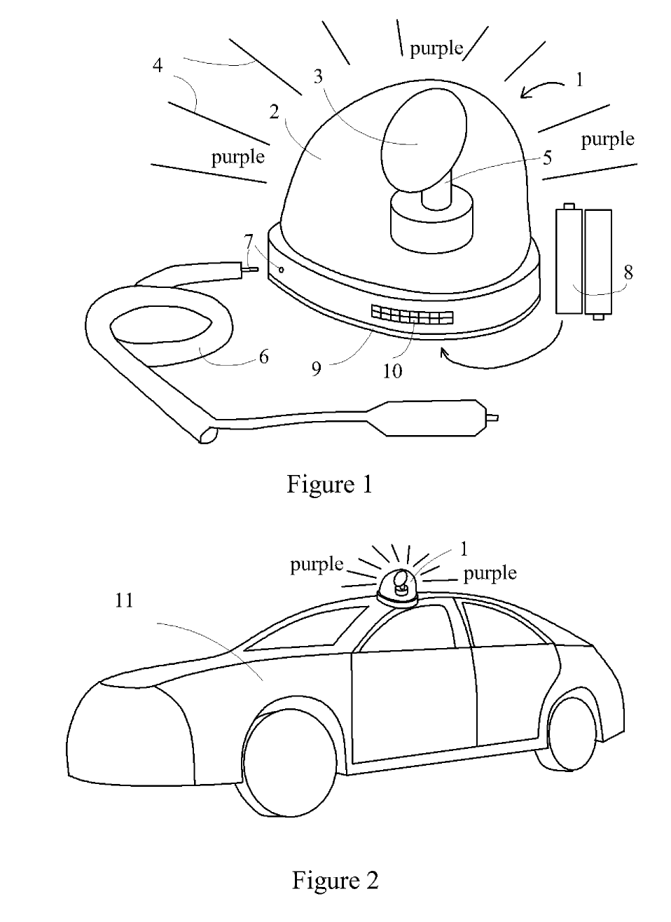

FIG. 1 illustrates a purple funeral procession identification light 1 in accordance with an embodiment of the invention. This light is has a purple-colored dome 2 which allows light to pass therethrough, and the purpose of employing purple is to establish purple as the universal identifier with respect to identifying a car in a funeral procession. Within the purple dome is a light emitting apparatus 3 which, when it is turned on and emitted through purple dome 2, will cause purple-colored light to be emitted 4 through the purple-colored dome 2 and, preferably, projected horizontally in a manner which can be observed from in all directions. Preferably, the light is mounted on a swivel 5 which causes the light to continuously rotate thereby emitting flashing, pulsating purple light in all directions in a manner that captures attention of other vehicles nearby. It is understood that means known in the art other than rotation of light emitting apparatus 3 may also be used to create flashing, pulsating light and are considered to be within the scope of this disclosure and its associated claims. And, while FIG. 1 illustrates purple-colored dome 2 comprising a rounded “teardrop” shape which is commensurate with the grief of parties in the funeral procession, it is understood that other shapes may be equally employed within the scope of this disclosure and its associated claims. This would include cross sections for purple-colored dome 2 comprising a range of circular, oval, and elliptical, shapes, as well as, for example, not limitation, square and rectangular shapes.

Power is supplied in any of a number of ways known in the art. Three sources of power are illustrated, for example, not limitation. A lighter adapter 6 may be used which plugs into funeral procession identification light 1 via male and female receptacles mating receptacles 7 in the customary manner, and then into a cigarette light socket inside the vehicle. Alternatively, for example, power may be supplied by a suitable battery or batteries 8 which are suitably situated near or within funeral procession identification light 1, or, for example, by a suitably-mounted solar power device 10. A rooftop attachment and detachment mount 9 for mounting and dismounting the funeral procession identification light 1 to and from the roof of a motor vehicle, such as but not limited to, a scratch-protective magnet, is used to attach the funeral procession identification light 1 atop a motor vehicle 11 such that funeral procession identification light 1 remains safely and reliably affixed while vehicle 11 is in transit, and to allow ready detachment following the procession.

Turning to FIG. 2, when a motor vehicle 11 is to be in a funeral procession, purple funeral procession identification light 1 is mounted to the roof of vehicle 11 using rooftop attachment device 9 in such a location that it is visible from all directions. Power (6, 7, 8, 10) is supplied, and the light is activated. Other vehicles in the funeral procession are provided with similar light for mounting, and said lights are mounted on the other vehicles as well (assuming the vehicle owner is willing to do so). When the procession is in transit, cars in the procession can easily identify one another so that that can stay together. After the procession, the lights are dismounted. Additionally, as purple funeral procession identification light 1 is used in funeral processions on a regular basis, purple lighting will become universally identified as the indicator of a funeral procession, and other vehicles will come to recognize this until this recognition becomes as ubiquitous as the recognition of police and fire vehicles.

Because the light can be viewed from all directions, one does not need to be in a position to view headlights. Because this light does not depend on observing a particularly-shaped object as in U.S. Pat. No. 6,082,880, D410,208, and D410,401, the possibility of confusion or misunderstanding is reduced. Because the light is designed to be projected in all directions, one can be aware of the nearby presence of a funeral procession even without directly looking at one of the vehicles in the procession. If the light is flashing or pulsating, then is instantly draws unmistakable attention to the fact that the traffic bearing the light—the funeral procession—is not traffic as usual, and need to be approached safely, with care and respect.

As a method of doing business, this helps funeral service providers conduct funeral processions without incident, so that grieving friends and family can experience a smoothly-progressing event at a very difficult time in their lives, and so that unwarranted legal liabilities can be avoided.

While only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. An apparatus for identifying a motor vehicle in a funeral procession, comprising:
a purple-colored dome; and
a light-emitting apparatus contained within said purple-colored dome and emitting purple-colored light through said purple-colored dome.

2. The apparatus of claim 1, wherein said light emitting apparatus projects said purple-colored light through said purple colored dome in a substantially-horizontal direction.

3. The apparatus of claim 2, said light emitting apparatus projecting said purple-colored light wherein said purple-colored light can be seen by a driver of a vehicle not carrying said apparatus, without said driver looking directly at said apparatus.

4. The apparatus of claim 2, further comprising:
causing said light-emitting apparatus to continuously rotate about a swivel while emitting said purple-colored light through said purple-colored dome.

5. The apparatus of claim 1, further comprising:
causing said light-emitting apparatus to continuously rotate about a swivel while emitting said purple-colored light through said purple-colored dome.

6. The apparatus of claim 1, wherein said light-emitting apparatus emits flashing or pulsating purple-colored light.

7. The apparatus of claim 1, said purple-colored dome comprising a teardrop shape.

8. The apparatus of claim 1, further comprising:
a rooftop attachment and detachment mount for mounting and dismounting said purple-colored dome and said light-emitting apparatus therein, to and from a roof of the motor vehicle.

9. The apparatus of claim 1, further comprising:
a source of power.

10. The apparatus of claim 1, in combination with the motor vehicle, further comprising:
the motor vehicle, with said apparatus mounted thereon.

11. A method of identifying a motor vehicle in a funeral procession, comprising:
mounting an apparatus emitting purple-colored light atop the motor vehicle; and
activating said apparatus to emit said purple-colored light from atop the motor vehicle.

12. The method of claim 11, further comprising:
projecting said purple-colored light in a substantially-horizontal direction.

13. The apparatus of claim 12, further comprising projecting said purple-colored light wherein said purple-colored light can be seen by a driver of a vehicle not carrying said apparatus, without said driver looking directly at said apparatus.

14. The method of claim 11, further comprising:
emitting said purple-colored light from a light-emitting apparatus contained within a purple-colored dome of said apparatus, through said purple-colored dome.

15. The method of claim 14, further comprising:
continuously rotating said light-emitting apparatus about a swivel while emitting said purple-colored light through said purple-colored dome.

16. The method of claim 11, further comprising:
continuously rotating said light-emitting apparatus about a swivel while emitting said purple-colored light through a purple-colored dome of said apparatus.

17. The method of claim 11, further comprising:
emitting flashing or pulsating purple-colored light.

18. The method of claim 11, said apparatus comprising a purple-colored dome comprising a teardrop shape.

19. The method of claim 11, further comprising:
mounting said purple-colored dome and said light-emitting method therein, to a roof of the motor vehicle, using a rooftop attachment mount; and
after the funeral procession, dismounting said purple-colored dome and said light-emitting method therein, from the roof of the motor vehicle.

20. The method of claim 11, further comprising:
providing power to said apparatus.
